(19) United States
(12) Patent Application Publication
(10) Pub. No.: US 2026/0023150 A1
(43) Pub. Date: Jan. 22, 2026

(54) ELECTRONIC DEVICE AND METHOD FOR POSITIONING BASED ON SPATIAL INVERTED INDEX

(71) Applicant: ELECTRONICS AND TELECOMMUNICATIONS RESEARCH INSTITUTE, Daejeon (KR)

(72) Inventors: JaeJun Yoo, Daejeon (KR); JiWoo Han, Daejeon (KR); Junhaeng LEE, Daejeon (KR)

(21) Appl. No.: 19/216,059

(22) Filed: May 22, 2025

(30) Foreign Application Priority Data
Jul. 17, 2024 (KR) 10-2024-0094110

(51) Int. Cl. G01S 5/02

(52) U.S. Cl. CPC G01S 5/02524; G01S 2205/02

(57) ABSTRACT

Provided is an electronic device for performing a fingerprint technique, including a communication module, a memory, and a processor functionally connected to the communication module and the memory, wherein the processor is configured to receive signals of a plurality of positioning resources at a plurality of reference points within a specified area through the communication module, based on the received signals, identify reference points at which the received signals for each of the positioning resources are observable among the plurality of reference points, calculate space areas including all reference points at which the signals for each of the positioning resources are observable, and generate a positioning database (DB) by invert indexing the calculated space areas based on identification information of each of the positioning resources and store the positioning database (DB) in the memory.

### CROSS-REFERENCE TO RELATED APPLICATION

This application claims priority to and the benefit of Korean Patent Application No. 10-2024-0094110, filed on Jul. 17, 2024, the disclosure of which is incorporated herein by reference in its entirety.

### BACKGROUND

### 1. Field of the Invention

Various embodiments disclosed in this document relate to indoor positioning technology.

### 2. Description of Related Art

Recently, as indoor spaces have become larger, many activities are conducted indoors, and mobile terminals such as smartphones have become essential for modern people. Accordingly, the demand for determining the location of mobile terminals in the indoors has also been increasing.

Unlike outdoor areas in which satellite-based positioning is possible through global navigation satellite system (GNSS) signal reception, the location of mobile terminals in GNSS signal shadow areas or indoor spaces may be estimated through other positioning methods based on wireless signals (wireless fidelity (WiFi), Long-Term Evolution (LTE), or Bluetooth Low Energy (BLE)) and sensor signals (geomagnetic sensors or images) of mobile terminals. As a representative example, the fingerprint technique is used to build a positioning database for wireless signals and sensor signals received in indoor spaces in advance. Subsequently, an electronic device determines the location of a mobile device by performing similarity search between information scanned by the mobile terminal and the positioning DB and selecting the location with the highest similarity as the location of the mobile terminal.

However, the fingerprint technique may require a significant amount of time to perform the similarity search between the information scanned at each location of the mobile terminal and the positioning DB. The similarity search may be processed more rapidly based on data structures, for example, an inverted index.

### SUMMARY OF THE INVENTION

Various embodiments disclosed in this document may provide an electronic device and a method for positioning based on spatial inverted index that are capable of improving the efficiency of a positioning database (DB)-based positioning method for a global navigation satellite system (GNSS) shadow area.

According to an embodiment, there is provided an electronic device for performing a fingerprint technique, which includes a communication module, a memory, and a processor functionally connected to the communication module and the memory, wherein the processor is configured to receive signals of a plurality of positioning resources at a plurality of reference points within a specified area through the communication module, based on the received signals, identify reference points at which the received signals for each of the positioning resources are observable among the plurality of reference points, calculate space areas including all reference points at which the signals for each of the positioning resources are observable, and generate a positioning database (DB) by invert indexing the calculated space areas based on identification information of each of the positioning resources and store the positioning database (DB) in the memory.

According to an embodiment, there is provided an electronic device, which includes a communication module; a spatial inverted index positioning database (DB) which includes a plurality of information about space areas corresponding to a plurality of positioning resources, wherein each space area includes all reference points at which each of the positioning resources are observable, and a processor functionally connected to the communication module and the positioning DB, wherein the processor is configured to, upon obtaining an observation signal from a mobile terminal within a specified area through the communication module, identify at least some positioning resources in the observation signal among the plurality of positioning resources, and determine a candidate location of the mobile terminal among the reference points by an intersection of the space areas corresponding to the identified positioning resources.

According to an aspect of the present invention, there is provided a spatial inverted index-based positioning method that is performed by at least one processor, which includes receiving signals of a plurality of positioning resources at a plurality of reference points within a specified area, based on the received signals, identifying reference points at which the received signals for each of the positioning resources are observable among the plurality of reference points, calculating space areas including all reference points at which the signals for each of the positioning resources are observable, and generating an inverted index of the calculated space areas based on each of the positioning resources.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram for describing a method of accelerating a similarity search between an inverted index data structure-based positioning database (DB) and a current location according to an embodiment;

FIG. 2 is a diagram for describing a polygon spatial inverted index positioning DB according to an embodiment;

FIG. 3 is a diagram for describing a spatial inverted index positioning DB based on minimum bonding rectangle (MBR) according to an embodiment;

FIG. 4 is a diagram illustrating a spatial inverted index MBR in an indoor space for measuring the location of a terminal according to an embodiment;

FIG. 5 is a diagram showing a configuration of an electronic device according to an embodiment;

FIG. 6 is a diagram showing a method of constructing a spatial inverted index-based positioning DB according to an embodiment; and

FIG. 7 is a diagram showing a method of using a spatial inverted index-based positioning DB according to an embodiment.

In relation to the description of the drawings, identical or similar reference numerals may be used for identical or similar components.

### DETAILED DESCRIPTION OF EXEMPLARY EMBODIMENTS

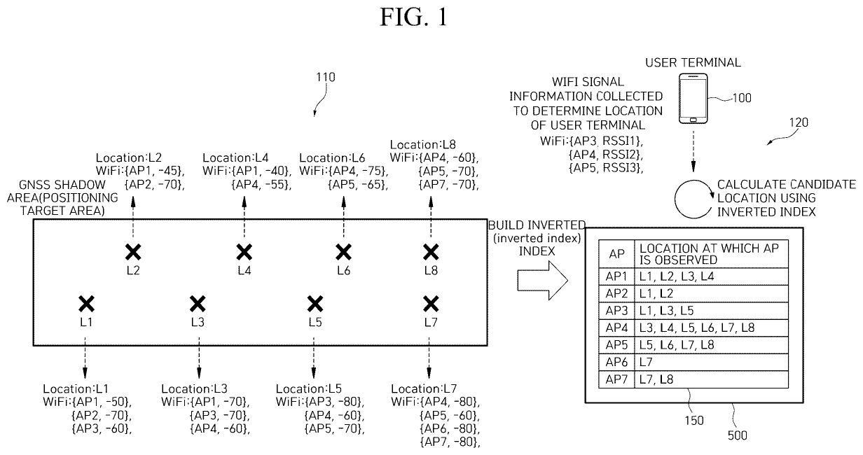

FIG. 1 is a diagram for describing a method of accelerating a similarity search between an inverted index data structure-based positioning database (DB) and a current location according to an embodiment. In this document, a case in which a positioning resource is a wireless fidelity (WiFi) access point (AP) is described as an example. However, it is not limited thereto. For example, the positioning resource may include various positioning resources such as Bluetooth Low Energy (BLE), Long-Term Evolution (LTE), etc.

Referring to FIG. 1, an electronic device 500 according to an embodiment may identify an RSSI value based on a signal received from a WiFi AP at first to eighth locations L1 to L8 in a global navigation satellite system (GNSS) shadow area. The electronic device 500 may construct a first positioning DB 150 by organizing positioning information into an inverted index. In an embodiment, the electronic device 500 may be, for example, a computing system of a positioning service provider. Herein, the first to eighth locations L1 to L8 are locations (points) at which signals for each AP (one of AP1 to AP7) are observed, and may be specified in advance by the service provider.

In operation 110, when the electronic device 500 may identify the first to eighth locations L1 to L8 within the GNSS shadow area, the APs (AP1 to AP7) observable at each location (one of L1 to L8) and the RSSI values of each AP may be identified. For example, the electronic device 500 may identify signals from WiFi AP1, WiFi AP2, and WiFi AP3 with RSSI values of −50, −70, and −60 dB, respectively, at the first location L1.

In operation 120, the electronic device 500 may construct an inverted index for at least some of the first to eighth locations L1 to L8, at which each AP may be observed, based on each AP. For example, the electronic device 500 may inversely index the first to fourth locations L1, L2, L3, and L4, at which AP1 may be observed, based on AP1, thereby representing the first to fourth locations L1, L2, L3, and L4 as a second row of a first positioning DB 150.

Thereafter, the electronic device 500 may obtain results of a WiFi scan around a user terminal 100 (e.g., a mobile terminal of a service user). When AP3, AP4, and AP5 are observed in the obtained scan results, the electronic device 500 may respectively search for an area in which all of AP3, AP4, and AP5 are present from the first positioning DB 150. For example, the electronic device 500 may identify the locations {L1, L3, L5} at which AP3 is present, {L3, L4, L5, L6, L7, L8} at which AP4 is present, and {L5, L6, L7, L8} at which AP5 is present from the inverted index of the first positioning DB 150, identify a value of a common intersection of the identified locations-{L1, L3, L5} {L3, L4, L5, L6, L7, L8} {L5, L6, L7, L8}, and calculate the identified location as a candidate location of the user terminal 100.

In this case, since only L5 is present as the value of the common intersection, the electronic device 500 may determine the location of the user terminal 100 as L5. When there are a plurality of candidate locations, additional processing may be performed to determine the final location from the candidate locations. For example, the electronic device 500 may determine the final location of the user terminal 100 by identifying an RSSI value in addition to the value of the common intersection.

However, in order to determine the location for an actual GNSS shadow area, the locations (e.g., L1 to L8 in FIG. 1) for pre-constructing a positioning DB or pieces of AP information collected at each location may increase to tens to hundreds or more. It may vary depending on the GNSS positioning environment, but the inverted index may also increase to hundreds of megabytes or more. In this case, since the number of WiFi signals collected by the user terminal also increases, not only the location identifications for each AP but also the intersection operations need to be performed as many as the number of WiFi signals collected. Therefore, calculating the candidate location of the user terminal using an inverted index may also require significant time and cost.

Hereinafter, a spatial inverted index technique according to an embodiment that may more efficiently calculate the candidate location will be described.

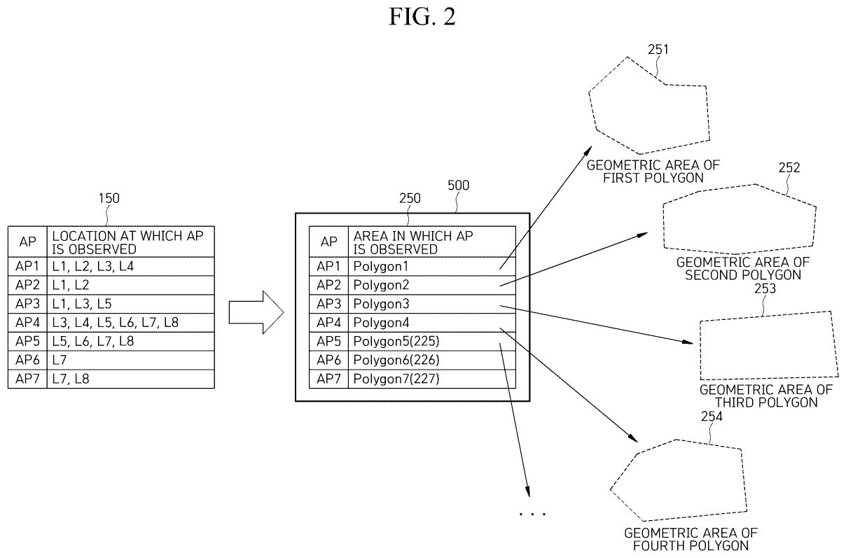

FIG. 2 is a diagram for describing a polygon spatial inverted index positioning DB according to an embodiment.

Referring to FIG. 2, the electronic device 500 may generate first to seventh polygon areas 351, 352, 353, 354, 355, 356, and 357 in which AP1 to AP7 are observed based on the first positioning DB 150 that is inversion-indexed based on AP1 to AP7. Accordingly, the electronic device 500 may configure a second positioning DB 220 that is spatially inverse-indexed with the first to seventh polygon areas 251, 252, 253, 254, 255, 256, and 257.

For example, the first polygon area 251 may be a minimum area including all locations (the first to fourth locations L1 to L4) at which AP1 is observed. The second polygon area 252 may be a minimum area including all locations (the first to second locations L1 to L2) at which AP2 is observed. The third polygon area 253 may be a minimum area including all locations (the first location L1, the third location L3, and the fourth location L4) at which AP3 is observed. The fourth polygon area 254 may be a minimum area including all locations (the third to eighth locations L3 to L8) at which AP4 is observed. The fifth polygon area 255 may be a minimum area including all locations (the fifth to eighth locations L5 to L8) at which AP5 is observed. The sixth polygon area 256 may be a minimum area including all locations (the seventh location L7) at which AP6 is observed. The seventh polygon area 257 may be a minimum area including all locations (the seventh and eighth locations L7 and L8) at which AP7 is observed.

In this document, for the convenience of explanation, a case in which the first to seventh polygon areas 351, 352, 353, 354, 355, 356, and 357 are configured based on a total of eight locations (e.g., reference points of FIG. 1) is described as an example. However, in practice, there may be more locations in which each AP (one of AP1 to AP7) is observed. Therefore, the electronic device 500 may configure a convex hull including all locations (reference points) at which each AP is observed, or a minimum polygon area including a convex hull.

In a case in which the second positioning DB 220 is used, when the electronic device 500 obtains a result of scanning nearby WiFi of the user terminal 100, AP3, AP4, and AP5 may be observed from the scanning result. In this case, the electronic device 500 may perform an operation of “{Polygon3 geometric area}∩{Polygon4 geometric area}∩{Polygon5 geometric area}” using the spatial inverted index of the second positioning DB 250 instead of the intersection operation of “{a list of locations in which AP3 is present}∩{a list of locations in which AP4 is present}∩{a list of locations in which AP5 is present}” to calculate the location of the user terminal 100.

As described above, when the spatial inverted index is used, even when each AP is observed in a wide range including hundreds to thousands of locations, the wide range may be simply expressed by a single polygon area including all points at which each AP is observed. However, when the locations at which each AP is observed are represented as a polygon area, the polygon area includes spatially more locations than locations of inverted index of the first positioning DB 150. However, since an AP observed at two locations is likely to be observed between the two locations, the method of representing the locations as a polygon area more accurately represents the observed locations of the AP in practice.

However, the second positioning DB 250 based on the spatial inverted index may be composed of a very complex polygon area depending on the construction situation or the spatial environment of the GNSS shadow area. In this case, performing an intersection operation based on the vertices of the complex polygon may be complicated. In addition, updating the polygons due to changes in the AP observation location may also be complicated.

Hereinafter, a method of constructing a spatial inverted index positioning DB that may simplify the spatial inverted index polygon operation is described.

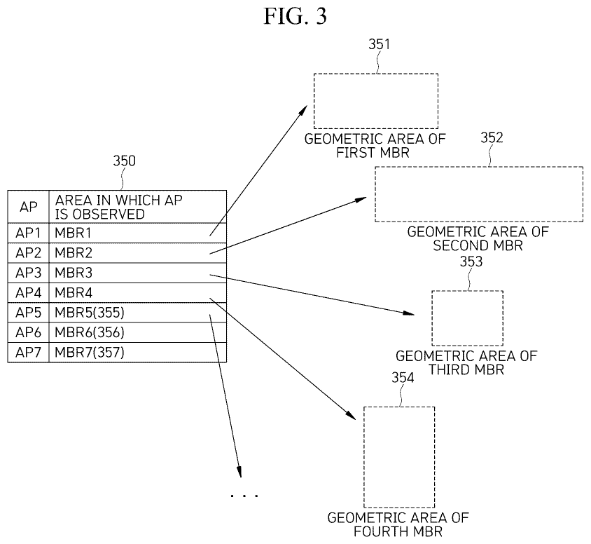

FIG. 3 is a diagram for describing a spatial inverted index positioning DB based on minimum bounding rectangle (MBR) according to an embodiment.

Referring to FIG. 3, an electronic device 500 according to an embodiment may calculate a minimum bounding rectangle (MBR) including each polygon area. For example, the electronic device 500 may calculate a minimum value min_x and a maximum value max_x of the x-axis, and a minimum value min_y and a maximum value max_y of the y-axis in each of the first to seventh polygon areas 251, 252, 253, 254, 255, 256, and 257. The electronic device 500 may calculate a rectangle having the minimum coordinate value (min_x, min_y) as the lower left corner and the maximum coordinate value (max_x, max_y) as the upper right corner. Accordingly, the electronic device 500 may produce the first to seventh MBR regions 351, 352, 353, 354, 355, 356, and 357 including the first to seventh polygon areas 251, 252, 253, 254, 255, 256, and 257, respectively.

As described above, the electronic device 500 according to an embodiment may greatly simplify the structure and size of the inverse index because regions in which each AP is observed are expressed as one MBR, so that even when one AP is observed at hundreds to thousands of points, the points correspond to one MBR.

In addition, the electronic device 500 according to an embodiment may simply update MBR even when the observation location of an AP changes, and the search for a candidate location at which a plurality of APs is all observed may be very efficiently computed by constructing the intersection of the MBRs.

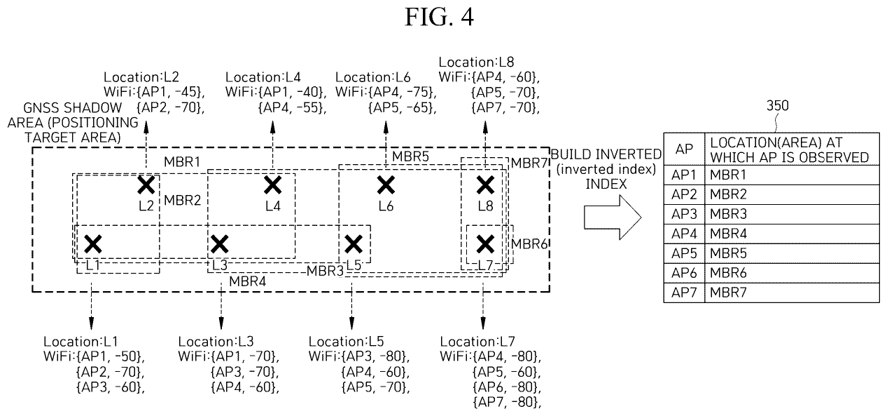

FIG. 4 is a diagram illustrating a spatial inverted index MBR in an indoor space for measuring the location of a terminal according to an embodiment.

Referring to FIG. 4, an electronic device 500 according to an embodiment may construct a third positioning DB 350 by performing spatial inverted indexing on the first to eighth locations L1 to L8 of an indoor space (a GNSS shadow area) into the first to seventh MBRs MBR1 to MBR7 obtained by connecting points at which AP1 to AP7 are observed.

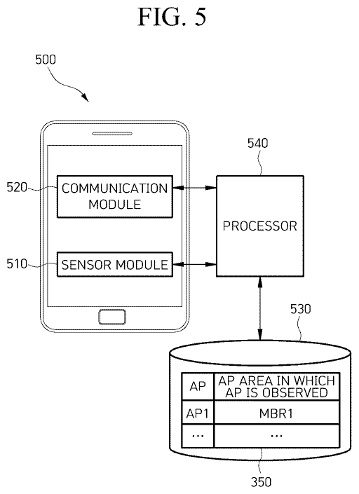

FIG. 5 is a diagram showing a configuration of an electronic device according to an embodiment.

Referring to FIG. 5, an electronic device 500 according to an embodiment may include a sensor module 510, a communication module 520, a memory 530, and a processor 540. In an embodiment, in the electronic device 500, some components may be omitted or additional components may be added. For example, the electronic device 500 may collect positioning resources and observation information of a GNSS shadow area (e.g., an indoor space or a tunnel) (hereinafter, referred to as a “target area”) through a measuring mobile terminal within the GNSS shadow area. In this case, the sensor module 510 may be omitted, and the communication module 520 may be used for communication of the measuring mobile terminal. In FIG. 5, a case in which the electronic device 500 includes a measuring mobile terminal is described as an example. In addition, some of the components of the electronic device 500 may be combined to form a single component but may perform the same functions of the components before the combination.

The sensor module 510 may include at least one of a geomagnetic sensor and a camera. The sensor module 510 may output a detection signal related to the attitude of the electronic device 500 through the geomagnetic sensor under the control of the processor 540. The sensor module 510 may capture an image of the surroundings of the electronic device 500 through a camera under the control of the processor 540.

The communication module 520 may support the establishment of a communication channel or a wireless communication channel between the electronic device 500 and another device (e.g., a WiFi access point (AP)), and the performance of communication through the established communication channel. The communication channel may include, for example, at least one of local area network (LAN), fiber to the home (FTTH), a digital subscriber line (xDSL), wireless broadband (WiBro), Wireless LAN, WiFi, Bluetooth, Zigbee, WFD (Wi-Fi Direct), UWB (Ultrawideband), infrared data association (IrDA), Bluetooth Low Energy (BLE), near field communication (NFC), 3G, 4G, or 5G. The communication module 520 may perform communication using known communication methods such as code division multiple access (CDMA), Global System for Mobile Communications (GSM), W-CDMA, time division-synchronous code division multiple access (TD-SCDMA), WiBro, Long Term Evolution (LTE), and Evolved Packet Core (EPC), etc.

The memory 530 may include various types of volatile memories or nonvolatile memories. For example, the memory 530 may include a read only memory (ROM) and a random-access memory (RAM). In an embodiment, the memory 530 may be located inside or outside the processor 540, and the memory 530 may be connected to the processor 540 through various known means. The memory 530 may store various types of data used by at least one component (e.g., the processor 540) of the electronic device 500. The data may include, for example, input data or output data for software and instructions related thereto. For example, the memory 530 may store at least one instruction and data for constructing a positioning DB 350 or providing a positioning service. According to an embodiment, the positioning DB 350 is stored in relation to the target area. The positioning DB 350 may include information related to reference points of the target area, information on each positioning resource, information on a space area inversely indexed with each positioning resource, and fingerprint information (e.g., RSSI values for each reference point, detection information for each reference point).

The processor 540 may control at least one other component (e.g., hardware or software component) of the electronic device 500 and may perform various data processing processes or calculations. The processor 540 may include, for example, at least one of a central processing unit (CPU), a graphics processing unit (GPU), a microprocessor, an application processor, an application specific integrated circuit (ASIC), and a field programmable gate array (FPGA), and may have a plurality of cores.

According to an embodiment, the processor 540 may receive signals of a plurality of positioning resources at a plurality of reference points within a target area via the communication module 520. The plurality of reference points may be, for example, points obtained by dividing the target area into grids of a specified unit (e.g., 1×1 m²). The positioning resources may include, for example, at least one wireless channel providing device among WiFi AP and Bluetooth modules.

According to an embodiment, the processor 540 may identify reference points at which signals for each of the positioning resources are observable (or receivable) among the reference points in positioning DB, based on the received signals. Referring to FIG. 4, for example, the processor 540 may identify observation information (RSSI values) of each of positioning resources based on signals received at each of the locations L1 to L8.

According to an embodiment, the processor 540 may calculate space areas including all reference points at which signals for each of the positioning resources are observable. Referring to FIGS. 2 to 4, the processor 540 may generate a first MBR including first to fourth locations in which the signal of an access point AP1 may be observed. For another example, the processor 540 may generate a minimum bounding rectangle (MBR), in which the minimum coordinate value L1 among coordinate values at which the signal of the access point AP1 is observed is set to the lower left corner and the maximum coordinate value L4 among the coordinate values is set to the upper right corner, as a MBR area of the access point AP1.

According to an embodiment, the processor 540 may construct a positioning DB 350 by inverting indexing (or, generating an inverted index of) the space areas in which each of the positioning resources may be observed based on each of the positioning resources.

According to an embodiment, the processor 540 may generate detection information related to the movement of the electronic device 500 through the sensor module 510 at each reference point. The processor 540 may store the generated detection information together with reception sensitivity information of received signals for each of the positioning resources for each reference point in the positioning DB 350 in the memory 530 as a fingerprint of each reference point.

According to an embodiment, the processor 540 may, upon receiving a signal at a current location of the user terminal 100 (a mobile terminal) within the target area through the communication module 520, determine a candidate location of the user terminal 100 based on an intersection of space areas including the current location. For example, the processor 540 may extract a reference point corresponding to the intersection of the space areas from the fingerprint of the positioning DB and compare a positioning resource acquired from the user terminal 100 and the extracted reference point to determine the candidate location of the user terminal. The processor 540 for example, may determine a reference point with a relatively high similarity among the reference points included in the intersection area based on the reception sensitivity information and the detection information as the final location of the user terminal 100.

According to an embodiment, the processor 540 may identify that a positioning resource has been added within the target area based on an observation signal from the user terminal 100. In this case, the processor 540 may calculate another space area in which the added positioning resource may be observed based on the observation signal. The processor 540 may update and store the added positioning resource and the space area in which the added positioning resource may be observed in the positioning DB. The observation signal may include identification information of the positioning resource and RSSI information. The observation signal may further include movement-related detection information (e.g., posture information) of the user terminal.

According to various embodiments, the user terminal 100 may be a terminal in which a positioning service application is installed. The user terminal 100 may access the positioning DB 350 of the electronic device 500 and determine the current location based on the observation signal.

As described above, the electronic device 500 according to an embodiment may support faster calculation of the candidate location and final location of the user terminal 100 by adding spatial information (MBR information) to the inverted index of the positioning DB 350 for determining the candidate location of the user terminal 100 in the GNSS shadow area (indoor).

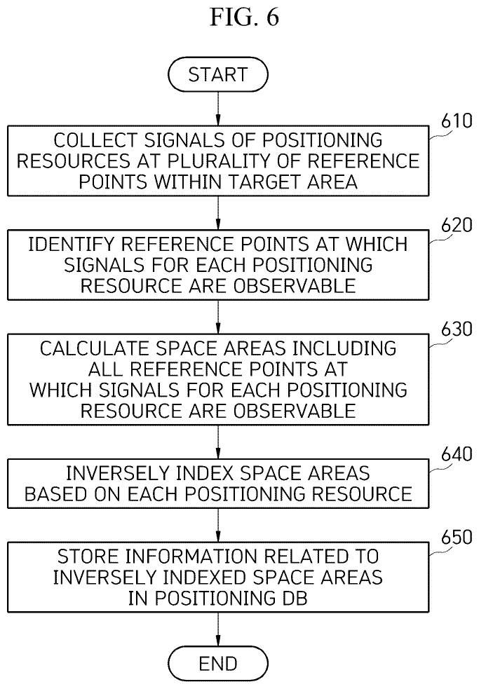

FIG. 6 is a diagram showing a method of constructing a spatial inverted index-based positioning DB according to an embodiment.

Referring to FIG. 6, in operation 610, the electronic device 500 may collect signals of a plurality of positioning resources at a plurality of reference points within a target area. The reference points may be, for example, points obtained by dividing the target area into grids of a specified unit (e.g., 1×1 m²). The positioning resources may include, for example, at least one wireless channel providing device among a WiFi AP and a Bluetooth module.

In operation 620, the electronic device 500 may identify reference points at which signals for each positioning resource may be observed based on the collected signals among the reference points.

In operation 630, the electronic device 500 may calculate space areas including all reference points at which signals for each of the positioning resources may be observed. For example, the electronic device 500 may calculate an MBR in which the minimum coordinate value of the reference points at which signals for each of the positioning resources may be observed is set to the lower left corner and the maximum coordinate value is set to the upper right corner.

In operation 640, the electronic device 500 may inversely index the calculated space areas based on each of the positioning resources.

In operation 650, the electronic device 500 may store information related to the space areas inversely indexed based on each of the positioning resources in the positioning DB 350. The positioning DB 350 may store each of the positioning resources and each space area information in a 1:1 correspondence.

As described above, the electronic device 500 according to an embodiment may add spatial information (MBR information) to the inverted index of the positioning DB 350 for determining the candidate location of the user terminal 100 in a GNSS shadow area (indoor), thereby accelerating the future determination of the candidate location of the user terminal 100.

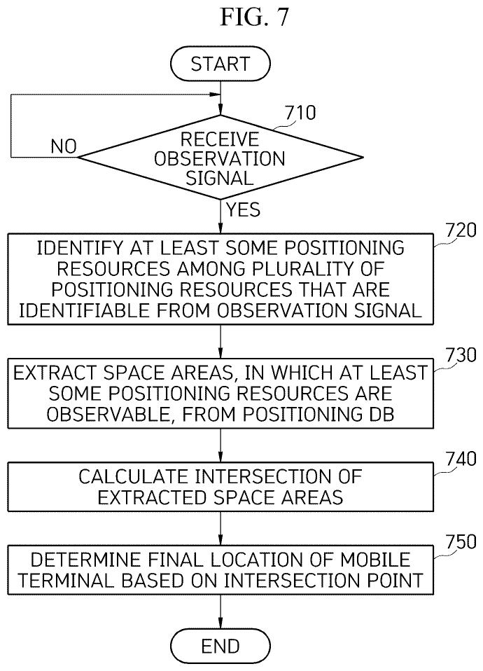

FIG. 7 is a diagram showing a method of using a spatial inverted index-based positioning DB according to an embodiment.

Referring to FIG. 7, in operation 710, the electronic device 500 may receive an observation signal from the user terminal.

In operation 720, the electronic device 500 may identify at least some positioning resources that may be identified from the observation signal among a plurality of positioning resources. For example, the electronic device 500 may identify the at least some positioning resources by identifying identification information of the positioning resources from the observation signal.

In operation 730, the electronic device 500 may extract space areas, in which the at least some positioning resources may be observed, from the positioning DB 350.

In operation 740, the electronic device 500 may extract a reference point (hereinafter, refer to ‘intersection point’) corresponding to the intersection of the extracted space areas.

In operation 750, the electronic device 500 may determine a candidate location of the user terminal based on the intersection point. For example, after extracting the intersection point, the electronic device 500 may identify other fingerprint information related to the intersection point from the observation DB, and when the similarity between the other fingerprint information and reception sensitivity information of observation signal is greater than a specified threshold, determine the extracted area as a candidate location of the user terminal.

As described above, the electronic device 500 according to an embodiment may support faster calculation of the candidate location and the final location of the user terminal 100 by adding spatial information (MBR information) to the inverted index of the positioning DB 350 for determining the candidate location of the user terminal 100 in a GNSS shadow area (indoors).

The various embodiments of the disclosure and terminology used herein are not intended to limit the technical features of the disclosure to the specific embodiments, but rather should be understood to cover all modifications, equivalents, and alternatives falling within the spirit and scope of the invention. Like numbers refer to like elements throughout the description of the drawings. The singular forms preceded by “a” and “an” corresponding to an item are intended to include the plural forms as well unless the context clearly indicates otherwise. In the disclosure, a phrase such as “A or B,” “at least one of A and B,” “at least one of A or B,” “A, B or C,” “at least one of A, B and C,” and “at least one of A, B, or C” may include any one of the items listed together in the corresponding phrase, or any possible combination thereof. Terms such as “first,” “second,” etc. are used to distinguish one element from another and do not modify the elements in other aspects (e.g., importance or sequence). When one (e.g., a first) element is referred to as being “coupled” or “connected” to another (e.g., a second) element with or without the term “functionally” or “communicatively,” it means that the one element is connected to the other element directly (e.g., by wire), wirelessly, or via a third element.

As used herein, the term “module” may include units implemented in hardware, software, or firmware, and may be interchangeably used with terms such as “logic,” “logic block,” “component,” or “circuit.” The module may be an integrally configured component or a minimum unit or part of the integrally configured component that performs one or more functions. For example, according to one embodiment, the module may be implemented in the form of an application-specific integrated circuit (ASIC).

The various embodiments of the present disclosure may be realized by software (e.g., a program) including one or more instructions stored in a storage medium (e.g., the memory 530 in FIG. 5) (e.g., an internal memory or external memory,) that can be read by a machine (e.g., an electronic device). For example, a processor (e.g., the processor 540) of the machine (e.g., the electronic device 500) may invoke and execute at least one instruction among the stored one or more instructions from the storage medium. Accordingly, the machine operates to perform at least one function in accordance with the invoked at least one command. The one or more instructions may include code generated by a compiler or code executable by an interpreter. The machine-readable storage medium may be provided in the form of a non-transitory storage medium. Here, when a storage medium is referred to as “non-transitory,” it can be understood that the storage medium is tangible and does not include a signal (for example, electromagnetic waves), but rather that data is semi-permanently or temporarily stored in the storage medium.

According to one embodiment, the methods according to the various embodiments disclosed herein may be provided in a computer program product. The computer program product may be traded between a seller and a buyer as a product. The computer program product may be distributed in the form of a machine-readable storage medium (e.g., a compact disc read only memory (CD-ROM)) or may be distributed directly between two user devices (e.g., smartphones) through an application store (e.g., Play Store™), or online (e.g., downloaded or uploaded). In the case of online distribution, at least a portion of the computer program product may be stored at least semi-permanently or may be temporarily generated in a machine-readable storage medium, such as a memory of a server of a manufacturer, a server of an application store, or a relay server.

Components according to various embodiments of the disclosure may be implemented in the form of software or hardware, such as a digital signal processor (DSP), an FPGA or an ASIC, and may perform predetermined functions. The term “elements” is not limited to meaning software or hardware. Each of the elements may be configured to be stored in a storage medium capable of being addressed and configured to execute one or more processors. For example, the elements may include elements such as software elements, object-oriented software elements, class elements, and task elements, processes, functions, attributes, procedures, subroutines, segments of program code, drivers, firmware, microcode, circuits, data, databases, data structures, tables, arrays, and variables.

According to the various embodiments, each of the above-described elements (e.g., a module or a program) may include a singular entity or a plurality of entities. According to various embodiments, one or more of the above-described elements or operations may be omitted, or one or more other elements or operations may be added. Alternatively, or additionally, a plurality of elements (e.g., modules or programs) may be integrated into one element. In this case, the integrated element may perform one or more functions of each of the plurality of elements in a manner the same as or similar to that performed by the corresponding element of the plurality of components before the integration. According to various embodiments, operations performed by a module, program, or other elements may be executed sequentially, in parallel, repeatedly, or heuristically, or one or more of the operations may be executed in a different order, or omitted, or one or more other operations may be added.

According to various embodiments disclosed in this document, the efficiency of a positioning DB-based positioning method for GNSS shadow areas can be improved. In addition, various effects that are directly or indirectly identified through this document can be provided.

What is claimed is:

1. An electronic device for performing a fingerprint technique, comprising:
a communication module;
a memory; and
a processor functionally connected to the communication module and the memory,
wherein the processor is configured to:
receive signals of a plurality of positioning resources at a plurality of reference points within a specified area through the communication module;
based on the received signals, identify reference points at which the received signals for each of the positioning resources are observable among the plurality of reference points;
calculate space areas including all reference points at which the signals for each of the positioning resources are observable; and
generate a positioning database (DB) by invert indexing the calculated space areas based on identification information of each of the positioning resources and store the positioning database (DB) in the memory.

2. The electronic device of claim 1, further comprising a sensor module,
wherein the processor is configured to, at each reference point,
detect a movement of the electronic device using the sensor module to generate detection information; and
store the generated detection information, together with reception sensitivity information of the received signals for each of the positioning resources at the each reference point as a fingerprint of the each reference point in the positioning DB.

3. The electronic device of claim 1, wherein the processor calculates a minimum bounding rectangle (MBR), in which a minimum coordinate value at which the received signals for each of the positioning resource are received is set to a lower left corner and a maximum coordinate value is set to an upper right corner, as the space area in which each of the positioning resources is observable.

4. The electronic device of claim 1, wherein, when receiving a signal at a current location of a mobile terminal within the specified area through the communication module, the processor determines a candidate location of the mobile terminal based on an intersection of space areas including the current location among the space areas.

5. The electronic device of claim 4, wherein the processor is configured to:
extract a reference point corresponding to the intersection of space areas; and
compare a positioning resource acquired from the mobile terminal and the reference point extracted from the fingerprint of the positioning DB to determine the candidate location of the mobile terminal.

6. The electronic device of claim 1, wherein each of the positioning resources includes at least one relay device among a wireless fidelity access point (WiFi AP) and a Bluetooth module.

7. An electronic device comprising:
a communication module;
a spatial inverted index positioning database (DB) which includes a plurality of information regarding space areas corresponding to a plurality of positioning resources, wherein each space area includes all reference points at which each of the positioning resources are observable; and
a processor functionally connected to the communication module and the positioning DB, wherein the processor is configured to:
upon obtaining an observation signal from a mobile terminal within a specified area through the communication module, identify at least some positioning resources in the observation signal among the plurality of positioning resources; and
determine a candidate location of the mobile terminal among the reference points by an intersection of the space areas corresponding to the identified positioning resources.

8. The electronic device of claim 7, wherein reception sensitivity information of each of the positioning resources for each of the reference points and detection information related to a movement of the mobile terminal for measurement are further stored in the positioning DB.

9. The electronic device of claim 8, wherein the processor determines the candidate location of the mobile terminal based on a reference point with a relatively high similarity based on the reception sensitivity information and the detection information among the reference points included in the intersection area.

10. The electronic device of claim 7, wherein the processor calculates a minimum bounding rectangle (MBR), in which a minimum coordinate value at which signals for each of the positioning resource are observable is set to a lower left corner and a maximum coordinate value is set to an upper right corner, as a space area of each of the positioning resources.

11. The electronic device of claim 7, wherein, upon identifying that a positioning resource has been added within the specified area based on the observation signal from the mobile terminal, the processor calculates a space area for the added positioning resource based on the observation signal and updates the space area in the positioning DB.

12. The electronic device of claim 1, wherein each of the positioning resources includes at least one relay device among a wireless fidelity access point (WiFi AP) and a Bluetooth module.

13. A spatial inverted index-based positioning method that is performed by at least one processor, comprising:
receiving signals of a plurality of positioning resources at a plurality of reference points within a specified area;
based on the received signals, identifying reference points at which the received signals for each of the positioning resources are observable among the plurality of reference points;
calculating space areas including all reference points at which the signals for each of the positioning resources are observable; and
generating an inverted index of the calculated space areas based on each of the positioning resources.

14. The spatial inverted index-based positioning method of claim 13, further comprising storing information related to the inverted index of the space areas in a positioning database (DB).

15. The spatial inverted index-based positioning method of claim 13, further comprising:
detecting a movement of an electronic device using a sensor module at each reference point and generating detection information; and
storing the generated detection information together with reception sensitivity information of received signals for each of the positioning resources for each of the reference points as a fingerprint of each of the reference points in a positioning database (DB).

16. The spatial inverted index-based positioning method of 13, wherein the calculating includes calculating a minimum bounding rectangle (MBR), in which a minimum coordinate value of coordinate values, at which received signals for each of the positioning resources are received, is set to a lower left corner and a maximum coordinate value of the coordinate values is set to an upper right corner, as the space area in which each of the positioning resources is observable.

17. The spatial inverted index-based positioning method of claim 13, further comprising:
receiving an observation signal corresponding to a current location of a mobile terminal within the specified area; and
determining a candidate location of the mobile terminal based on an intersection of space areas including the current location.

18. The spatial inverted index-based positioning method of claim 17, wherein the determining of the candidate location includes:
extracting a reference point corresponding to the intersection of the space areas; and
comparing a positioning resource acquired from the mobile terminal and the extracted reference point from fingerprint of the positioning DB to determine the candidate location of the mobile terminal.

19. The spatial inverted index-based positioning method of claim 17, further comprising:
upon identifying that a positioning resource being added within the specified area based on the observation signal from the mobile terminal, calculating a space area for the added positioning resource based on the observation signal; and
updating and storing the added positioning resource and the space area in a positioning database (DB).
